(19) United States
(12) Patent Application Publication
(10) Pub. No.: US 2020/0258079 A1
(43) Pub. Date: Aug. 13, 2020

(54) TEXT CURRENCY PLATFORM SYSTEM

(71) Applicant: In Young KIM, Namyangju-si (KR)

(72) Inventor: In Young KIM, Namyangju-si (KR)

(21) Appl. No.: 16/755,655

(22) PCT Filed: Nov. 30, 2018
(86) PCT No.: PCT/KR2018/015049

§ 371 Date: Apr. 13, 2020

(30) Foreign Application Priority Data
Feb. 21, 2018 (KR) 10-2018-0020671

(51) Int. Cl. G06Q 20/38; G06Q 20/36

(52) U.S. Cl. CPC G06Q 20/386; G06Q 20/384; G06Q 20/3678

(57) ABSTRACT

A text currency platform system is disclosed. The system comprises: a text registration unit for newly registering a text, the registration of which is requested by a user; a text currency issuing unit for issuing a cryptocurrency for the registered text; a text post unit for posting the registered text; a supporter registration unit for registering, as supporters, other users supporting the posted text; a supporter activity check unit for checking each supporter's texting activity for informing of a support text; and a text currency payment unit for paying for a corresponding text currency according to each supporter's texting activity.

### TECHNICAL FIELD

The present invention relates to a cryptocurrency and, in particular, to text currency platform system for issuance and payment of cryptocurrency.

### BACKGROUND ART

A cryptocurrency is a kind of digital currency, and refers to a payment method that is issued and managed by a developer and is capable of being used in a specific virtual community or in the real world. Most cryptocurrencies are digital currencies and virtual currencies. Bitcoin is well-known as a representative cryptocurrency, and blockchain, a security technology used for bitcoin transactions is also well known. In addition, a person in charge of confirming that transaction records stored in the blockchain are correct and then approving the transaction is called a miner, and in order to encourage the miners to consume computing power and electricity, the Bitcoin system compensates the miners for their effort by rewarding the minors with newly minded bitcoins. However, since much computing power is consumed in order to mine the virtual currency such as Bitcoin, a problem of wasting power is emerging. In addition, due to a considerable amount of computing resources and a huge power consumption, it is virtually impossible for ordinary miners to mine cryptocurrency.

### DOCUMENTS OF RELATED ART

### Patent Document

Korean Patent Application Publication No. 10-1827373 (published on Feb. 8, 2108)

### DISCLOSURE

### Technical Problem

The present invention has an objective to provide a technical method for achieving a new type of cryptocurrency issuance and payment service that can solve a problem caused by a considerable amount of computing resources and a huge power consumption.

### Technical Solution

A text currency platform system according to an embodiment of the present invention includes a text registration unit newly registering a text, the registration of which is requested by a user; a text currency issuing unit issuing a cryptocurrency for the registered text; a text post unit posting the registered text; a supporter registration unit registering, as supporters, other users supporting the posted text; a supporter activity check unit checking a texting activity for informing of a support text for each supporter; and a text currency payment unit paying for a corresponding text currency according to the texting activity for each supporter.

The text currency issuing unit may determine an amount of currency issuance in consideration with a recognition level of the registered text, and issue the cryptocurrency as much as the determined amount of currency issuance.

The text currency issuing unit may determine the recognition level according to the number of search results for newly registered texts in a predetermined search engine.

The supporter activity check unit may be installed in a communication terminal for each supporter to check a texting activity of a supporter in association with an application that monitors the texting activity of the supporter. In addition, the texting activity may be text recording on a social media or text transmission using a messenger.

### Advantageous Effect

The disclosed system provides a text-based digital money issuance and payment service, by which there is an effect of solving the problem of a considerable amount of computing resources and power consumption as in the related art.

### DESCRIPTION OF DRAWINGS

FIG. 1 is a block diagram showing a text currency platform system according to an embodiment.

FIG. 2 is a block diagram showing a text currency server according to an embodiment.

FIG. 3 is a block diagram showing a communication terminal according to an embodiment.

FIG. 4 is a flowchart showing a method of providing a text currency service according to an embodiment.

### MODE FOR INVENTION

The foregoing and additional aspects of the invention will become more apparent through the preferred embodiments described with reference to the accompanying drawings. Hereinafter, the present invention will be described in detail so that those skilled in the art can easily understand and reproduce through the examples.

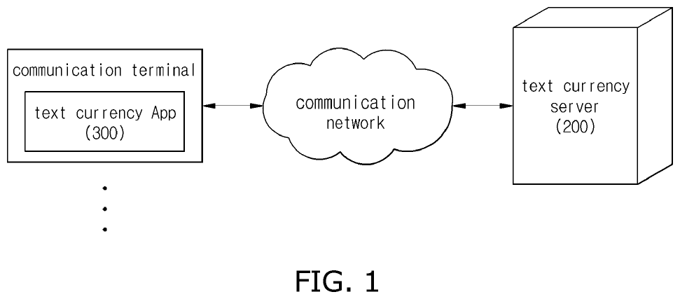

FIG. 1 is a block diagram showing a text currency platform system according to an embodiment. As shown in FIG. 1, the text currency platform system includes communication terminals 100 and a text currency server 200. The communication terminal 100 and the text currency server 200 may perform data communication through a communication network, and the communication network may be composed of one or multiple heterogeneous networks. The communication terminal 100 is a communication-enabled computing device used by users in order to use the text currency service provided by the text currency server 200. As the communication terminal 100, there is, for example, a smart phone or a smart pad. A text currency App 300, which is an application required to use the platform service, may be installed and executed in the communication terminal 100.

The text currency App 300 may provide various services related to text currency to a user by interworking with the text currency server 200, and monitor a specific activity of the user through the communication terminal 100. Alternatively, the text currency App 300 may have only a function of monitoring a member's specific activity. The text currency server 200 is a server that provides an online platform, and may be a server system including a GUI server, an application server, a database, a transaction server, and the like. The text currency server 200 according to an aspect issues a new digital currency called a text currency on the basis of a text, and performs a process of paying a text currency according to a predetermined activity of users. The text currency server 200 may provide text currency issuance and payment services based on membership.

Meanwhile, the text currency platform system does not necessarily include all components shown in FIG. 1, and may include only a part thereof. For example, the text currency platform system includes only the text currency server 200 and one or more text currency Apps 300 among the components shown in FIG. 1. As another example, the text currency platform system may include only the text currency server 200.

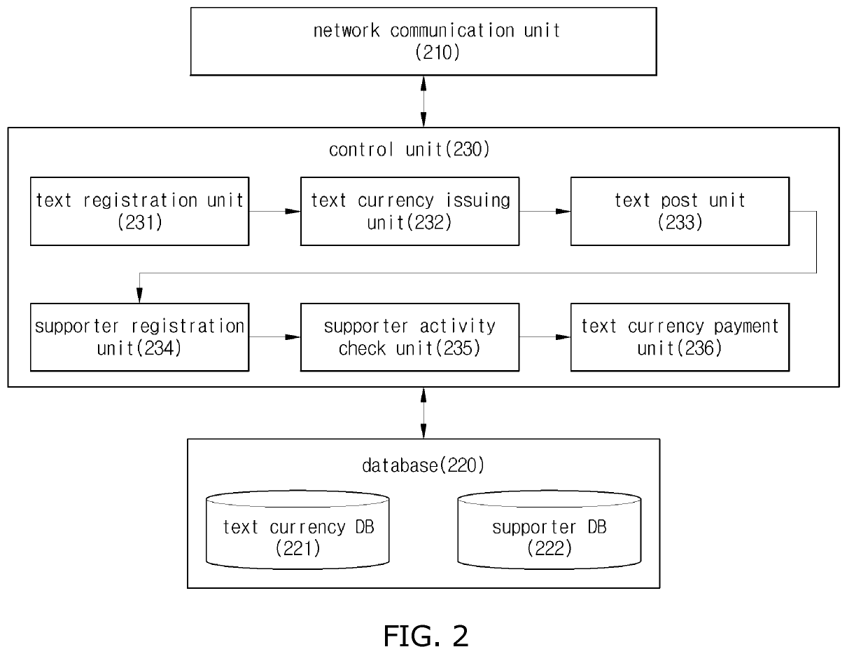

FIG. 2 is a block diagram showing a text currency server according to an embodiment. Referring to FIG. 2, the text currency server 200 may include a network communication unit 210, a database 220, and a control unit 230. The network communication unit 210 is a communication module for communicating with the communication terminals 100 through a communication network. The database 220 includes a text currency DB 221 and a supporter DB 222. In the text currency DB 221, new texts for issuing text currency may be registered, and text currency issued for each of the registered texts and data related thereto may be stored. In the supporter DB 222, a list of supporters in which users who support the registered texts are registered as supporters is stored. The supporter list may be generated for each registered text. The control unit 230 may be composed of a combination of hardware and software, in which the hardware may include one or more processors and memories, and the software may include an operating system.

The control unit 230 is a text registration unit 231, a text post unit 233, a text currency issuing unit 232, a supporter registration unit 234, a supporter activity check unit 235, and a text currency payment unit 236. These may all be executed by one or more processors, as configurations capable of being implemented in software. The text registration unit 231 receives, from the communication terminal 100, a text for which the user makes a request to register. The text may be a word, for example, “Coca-Cola” or “Gyeongbokgung”. The text registration unit 231 checks whether or not the received text is duplicated, and the duplication may be check in such a manner as to determine whether the received text is registered in the text currency DB 221 or not. When the text is not duplicated as a result of checking, the text registration unit 231 newly registers the text in the text currency DB 221, the registration of which is requested by the user.

The text currency issuing unit 232 generates a text currency, which is a cryptocurrency for the newly registered text, and newly issues the same. Herein, the text currency may be a digital currency that encrypts the registered text or a digital currency that encrypts other data that may identify the text, and the encryption method itself is not particularly limited. In addition, the issued text currency and data related thereto may be stored in the text currency DB 221. According to an embodiment, the text currency issuing unit 232 issues the text currency as much as the amount requested by the user. According to another embodiment, the text currency issuing unit 232 determines the amount of issuance in consideration of a recognition level of texts and then issues the text currency as much as the determined amount of issuance. Herein, the text recognition level may be determined through a search for the registered text in a predetermined search engine. For example, the text currency issuing unit 232 determines the number of searches for the registered text during the predetermined period as the amount of issuance. As another example, the text currency issuing unit 232 determines the amount of issuance in proportion to the number of searches for the registered texts during a predetermined period. Herein, a given search engine is, for example, Google.

The text post unit 233 posts newly registered text or text of newly issued text currency. According to an embodiment, the text post unit 233 posts the text on the online platform and notifies other users of the text to enable them to check the new registered text. In other words, the text post unit 233 notifies the communication terminal 100 or the text currency App 300 of each other user that there is a posted text, so that other users may access the online platform and then check the registered text. According to another embodiment, the text post unit 233 may post the text to other users in such a manner as to directly transmit the text to the text currency App 300 of other users.

The supporter registration unit 234 registers users who support the posted text among other users as supporters. According to an embodiment, the supporter registration unit 234 receives, from the text currency App 300, a request made by other user to be registered as a supporter, and registers the user in the supporter list according to the registration request. The supporter activity check unit 235 checks whether there is a texting activity to notify the text supported by each supporter. For example, when the support text is “Coca-Cola”, it is checked whether the supporter performed activities that informs the others of “Coca-Cola”. According to an embodiment, the supporter activity check unit 235 checks whether there is a texting activity in association with the supporter's text currency App 300. Herein, the texting activity may be text recording on a social media or text transmission using a messenger.

The text currency payment unit 236 may pay the text currency to a virtual currency account of the supporter according to the texting activity for each supporter. According to an embodiment, the text currency payment unit 236 pays a predetermined amount of text currency according to contents of activity or counts of activities. According to another embodiment, the text currency payment unit 236 pays a predetermined amount of text currency according to the counts of activities per a content of activity. Examples of the content of the activity include text recording on the social media described above or text transmission using a messenger.

Meanwhile, the text currency issuing unit 232 may generate a text currency for each of two or more different languages for a registered text. For example, when the registered text is Korean, the text currency may be generated and issued for each different language, such as Korean and English. Herein, the amount of issuance may be determined differently for each language. Specifically, the amount of issuance may be determined by the user or may be determined in consideration of the recognition level for each language. In addition, the recognition level for each language may be determined by through a search for the registered texts in a predetermined search engine for each language.

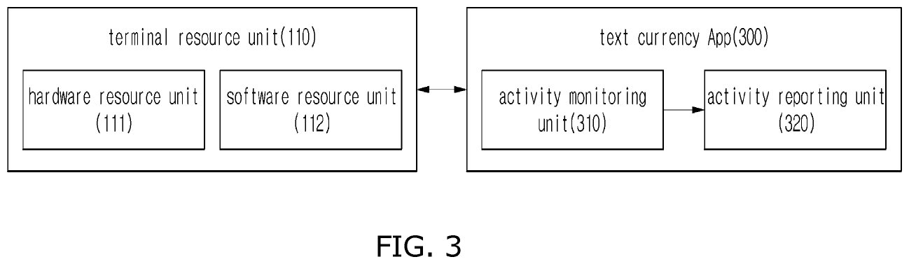

FIG. 3 is a block diagram showing a communication terminal according to an embodiment. As shown in FIG. 3, the communication terminal includes a terminal resource unit 110 and a text currency App 300. The terminal resource unit 110 includes a hardware resource unit 111 and a software resource unit 112. The hardware resource unit 111 is configured to include hardware resources, such as a processor, a memory, and a communication module, and the like in the communication terminal 100; and the software resource unit 112 is configured to include software resources such as an operating system, a social media App, and the like in the communication terminal 100. At least some resources of the terminal resource unit 110 may be accessed by the text currency App 300.

The text currency App 300 is an application that is installed and executed in the communication terminal 100 to interwork with the text currency server 200, and may provide text currency platform service to users. As shown in FIG. 2, the text currency App 300 may include an activity monitoring unit 310 and an activity reporting unit 320. The activity monitoring unit 310 performs a function of monitoring a predetermined texting activity for a text supported by the user. According to an embodiment, the text currency App 300 may monitor whether a user records a text that the user supports on a social media using an application for social media, such as Twitter, Facebook, or Instagram, or the user delivers the text supported by the user to others by using a messenger app, such as KakaoTalk or Line. For such monitoring, the activity monitoring unit 310 may access at least some resources of the terminal resource unit 110. The activity reporting unit 320 reports the texting activity of the user monitored by the activity monitoring unit 310 to the text currency server 200. Accordingly, the supporter activity check unit 235 of the text currency server 200 receives the texting activity from the text currency App 300 and checks the texting activity of the user according to the report.

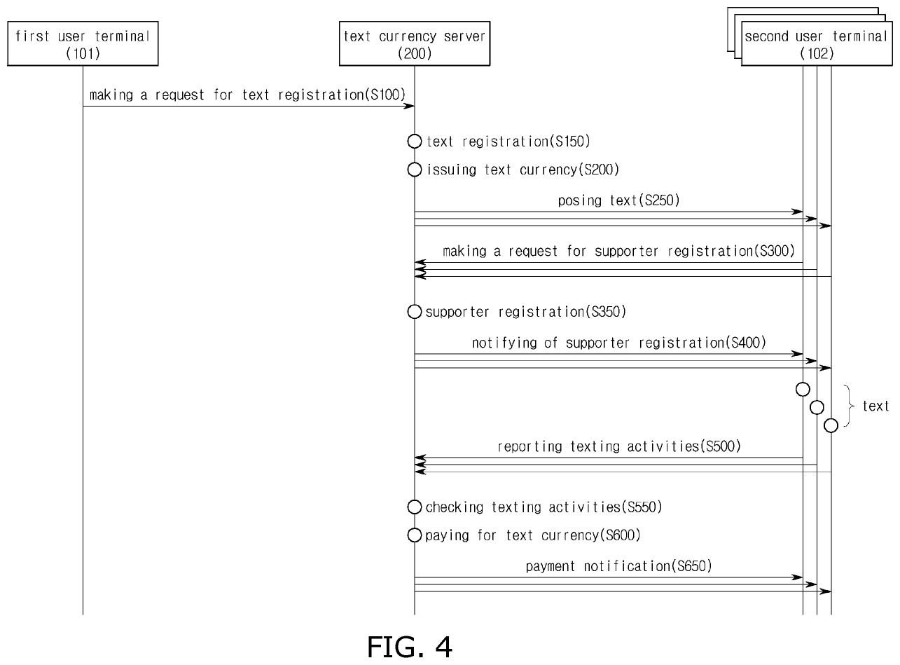

FIG. 4 is a flowchart showing a method of providing a text currency service according to an embodiment. In FIG. 4, a first user terminal 101 refers to a communication terminal of a user (first user) requesting text registration, and a second user terminal 102 refers to a communication terminal of other users (second user). In addition, the operation of the first user terminal 101 illustrated in FIG. 4 may be performed by the text currency App of the first user terminal 101, and the operation of the second user terminal 102 may be performed by the Text currency App of the second user terminal 102. First, the first user terminal 101 makes a request for registration of the text designated by the first user to the text currency server 200 (S100). Accordingly, the text currency server 200 registers the registration-requested text as a new text (S150). Herein, the text currency server 200 checks whether the registration-requested text is duplicated or not, and the text may be registered as a new text when it is determined the text is not registered as a result of checking.

The text currency server 200 issues a text currency for the newly registered text (S200). Herein, the text currency server 200 performs a process of determining the amount of issuance. The amount of issuance may be determined by the amount requested by the first user, and may be determined in consideration of the recognition level of the corresponding text. Then, the text currency server 200 posts the new registered texts to the second users (S250). For example, the text currency server 200 notifies the second user terminals 102 of the newly registered texts. Accordingly, the second users enable checking the newly registered texts. Each of the second user terminals 102 makes a request for supporter registration for the newly registered text to the text currency server 200 according to a request of the second user (S300). Accordingly, the text currency server 200 performs supporter registration and notifies the second user terminals 102 that the supporter registration is completed (S350) (S400). Subsequently, the second user terminals 102 monitor whether the texting activities are performed by the second users and report the texting activities to the text currency server 200 when the texting activities are checked through monitoring (S450) (S500).

The text currency server 200 checks the texting activity of the second user according to the texting activity report for each second user terminal 102, and pays the second user for the text currency to a checking result (S550) (S600). Herein, the text currency may be paid as an electronic wallet opened by the second user to hold the cryptocurrency. When the text currency payment is completed, the text currency server 200 performs payment notification for each second user terminal 102 (S650). Meanwhile, in the above-described process, the text posting (S250) may be performed concurrently with the issuance of the text currency (S200), or may be performed earlier.

So far, the present invention has been focused on the preferred embodiments. Those skilled in the art to which the present invention pertains will understand that the present invention may be implemented in a modified form without departing from the essential characteristics of the present invention. Therefore, the disclosed embodiments should be considered in terms of explanation, not limitation. The scope of the present invention is shown in the claims rather than the foregoing description, and all differences within the equivalent range should be interpreted as being included in the present invention.

### DESCRIPTION OF REFERENCE NUMERALS IN DRAWINGS

100: communication terminal 110: terminal resource unit

111: hardware resource unit 112: software resource unit

200: text currency server 210: network communication unit

220: database 221: text currency DB

222: supporter DB 230: control unit

231: text registration unit 232: text currency issuing unit

233: text post unit 234: supporter registration unit

235: supporter activity check unit 236: text currency payment unit

300: text currency App 310: activity monitoring unit

320: activity reporting unit

1. A text currency platform system, comprising:
a text registration unit newly registering a text, the registration of which is requested by a user when the requested text for registration is defined as non-duplicated as a result of checking whether or not a text is duplicated;
a text currency issuing unit issuing a cryptocurrency for the newly registered text, wherein the text currency issuing unit determines an amount of currency issuance in consideration with a recognition level of the newly registered text, and issues the cryptocurrency as much as the determined amount of currency issuance;
a text post unit posting the newly registered text;
a supporter registration unit registering users that support the posted text among other users as supporters;
a supporter activity check unit checking a texting activity of each supporter, wherein the texting activity is to inform other users of a support text of each supporter; and
a text currency payment unit paying for a predetermined amount of issued cryptocurrency, corresponding to the text according to the texting activity of a supporter, to the supporter.

2. The text currency platform of claim 1, wherein the text currency issuing unit determines the recognition level according to the number of search results for newly registered texts in a predetermined search engine.

3. The text currency platform of claim 1, wherein the supporter activity check unit is installed in a communication terminal for a supporter to check a texting activity of the supporter in association with an application that monitors the texting activity of the supporter.

4. The text currency platform of claim 1, wherein the texting activity is text recording on a social media or text transmission using a messenger.

5. (canceled)
